(19) United States
(12) Patent Application Publication
(10) Pub. No.: US 2020/0030843 A1
(43) Pub. Date: Jan. 30, 2020

(54) MIXING DEVICE AND APPLICATOR FOR SEALANTS

(71) Applicant: Daniel Ortiz García, Valencia (ES)

(72) Inventor: Daniel Ortiz García, Valencia (ES)

(21) Appl. No.: 16/332,423

(22) PCT Filed: Sep. 6, 2017
(86) PCT No.: PCT/ES2017/070598

§ 371 Date: Mar. 12, 2019

(30) Foreign Application Priority Data
Sep. 20, 2016 (ES) P201600784

(51) Int. Cl. B05C 17/01; B01F 9/02; B01F 15/02

(52) U.S. Cl. CPC B05C 17/01; B01F 2215/006; B01F 15/02; B01F 9/02

(57) ABSTRACT

Mixing device and applicator for sealants formed by a main body and a handle (1), wherein the main body comprises a container-carrying sheath (7), a rotating cylinder (14), a gear module (11) that can be coupled to a rotor and a set of mechanisms that eject the sealant material. By actuating a trigger (2), a speed regulator (3) and a rotation selector (4) present in the handle (1) in a first action the cylinder (11) rotates in one sense mixing the material and in a second action it changes the sense of rotation and by actuating a cylinder locking system (19 and 20) present in the main body the device ejects the sealant material.

### TECHNICAL FIELD

The disclosed invention falls within the sector of accessories or devices used in the mixing or application of materials which are intended for sealing joints.

Further specifying the sector for which it is intended, the disclosed invention falls within the sector of devices used with the aforementioned aim, the form of mixing or application of which requires a mechanical action produced in a non-manual way.

### STATE OF THE ART

At the date of completion of the present specification, a variety of systems or devices are known which have the aforementioned aim in the sector of the art carried out in independent devices.

A series of devices are known which use a mechanical action for the mixing or application thereof. The majority of said devices, independent for each action, consist of a housing whereon the container rests wherein the material to be applied is housed and the form of application of which is carried out by means of the pressure exerted by a plunger coupled to a guide which is actuated manually by a trigger.

Devices are also known which are solely intended for the mixing of two or more components.

The same holder of the present invention is in turn the holder of two inventions which are similar in principle and which are explained below;
WO2014198966 titled Device for mixing and applying a compound produced by mixing two products. It describes a device made up of a rotating casing with locking means wherein it houses the container with the material to be applied, a mobile plunger with the actuating means thereof and means for fixing the entire assembly to a drill or similar.
ES2578808 titled Device for applying products contained in a container with a piston. Like the previous one, it describes a mechanical device made up of a casing which houses actuating gears, an extendable shaft, telescopic guides and a second casing wherein the container is housed which stores the material to be applied, all of this being able to be coupled to a drill or similar.

Both inventions are devices which require actuating means external to them such as a drill or a device comprising a rotor.

Although it is true that said devices are related in principle and are similar to a certain degree to the one disclosed herein, the similarity of these as far as the form of embodiment relates, they differ in a relevant manner from the proposed invention.

### OBJECT OF THE INVENTION

As mentioned in the state of the art, the devices currently existing, including those of the holder, depend on auxiliary forces for the operation thereof, or rather the force of a person or even the force generated through a drill or device with a rotor that can be coupled to the devices.

Due to the nature of the conditions to which the joint of certain materials or parts are exposed, these require a sealing or leak-tightness made with a specific material. Said material tends to be the result of a mixture of two or more components and which in turn must be performed in the moment of application thereof due to the chemical compositions which make it up. Precisely the chemical characteristics of these compounds are what forces the mixture to be performed in a specific manner and condition imposed by the manufacturer in order to ensure the reliability thereof.

The existing devices, including those of the holder of the disclosed invention, do not completely meet, in all the context thereof, the mixing and application conditions required in the circumstances explained previously due to the fact that the actuating means of said devices do not envisage certain regulating characteristics necessary when mixing and applying certain compounds. This leads to the performance of a sealing or leak-tightness in the majority of cases with questionable reliability which can translate into terrible consequences.

Another drawback that said devices have is that of performing the mixing and application actions independently since some are only for performing the mixing and others for the subsequent application thereof. Even the aforementioned inventions of the holder are dependent on other external devices.

In the field of aeronautics it is common to use sealant materials originally coming from biocomponent containers which require the aforementioned actions of mixing and applying.

The disclosed invention intends to provide a device which apart from ensuring a correct mixing and application of the compound by means of an ideal regulation pursuant to the conditions recommended by the manufacturers thereof in order to ensure the reliability thereof, performs the mentioned actions in a single device without additions from or dependence on other devices.

### DESCRIPTION OF THE INVENTION

The mixing device and applicator for sealants which, according to the title and in a selectable manner in one action mixes and in another action applies a sealant material, is configured starting from a drill-like or similar appearance comprising a handle wherein a trigger, a speed selector and a rotation changer are arranged.

It is characterised in that the mechanical components responsible for performing the aforementioned actions are on the handle as described below;
Mixing.
In the front upper portion of said handle a removable sheath is arranged whereon the container of the material to be mixed is introduced, said container acts as a stop on the same, fitting to the sheath by means of the rotation of a head with a retention ring present therein and is coupled to the device by means of an anchoring system with rotation.
Said coupling is carried out inside a rotating cylinder present in the device and which by means of the actuation of the rotation selector and the trigger present in the handle is rotated in the sense selected for the mixing by means of the action of a rotor present in the rear portion of the device. The rotational movement of the cylinder is transferred from the rotor to the same through an adapter formed on one end in a geometric shape with edges and introduced into a cavity with the same geometric shape arranged inside the cylinder.
The longitudinal retention of the rotating cylinder towards the outside of the device is a consequence of the stop action of a circular protrusion in the outline of the cylinder with an intermediate bearing and this in turn with a closing bushing present in the front portion of the device. The name closing bushing comes from it performing the functions of closing the enclosure or casing which covers the mechanisms present in the device.
Application.
Once the mixing is performed in a homogeneous manner specified by the manufacturer in time and rotation speed, and already in the stop position, the rotation of the cylinder is then locked by means of a manual braking system present in the upper portion of the closing bushing and resting on the anchoring area of the sheath with the cylinder. By means of changing the rotation of the cylinder performed through the actuator present in the handle and the subsequent actuation of the trigger, a plunger coupled to a longitudinal telescopic shaft gathered inside the adapter is ejected longitudinally forwards thus proceeding to the ejection of the material to be applied by means of the contact made by the plunger on the piston present inside the container.

A group of gears with a clutch comprised inside the device is responsible for reducing and adapting the speeds of the rotation and the torque generated by the rotor and transmitted to the cylinder both in the mixing action and in the application action of the sealant material.

The movement of the rotor presents the possibility of being generated either by means of an electric motor regulated by electronic components housed inside the device or by means of an integrated pneumatic system.

Although the use of the device is not discarded for use in the application of other commonly used sealants, the use thereof is intended for the mixing and application of a material, which in particular requires the involvement of the user accompanying the rotations performed by the container in the device during the mixing with longitudinal movements of a piston located in the ejection mouth of the sealant and coupled to a helix present inside the container.

### BRIEF DESCRIPTION OF THE DRAWINGS

With the aim of not limiting said invention in the variety of embodiments thereof and always respecting the unity of invention, an optional embodiment of the device is illustrated below.

FIG. 1. Shows a perspective view of the device.

FIG. 2. Shows a perspective view of the device with the container of the sealing material incorporated.

FIG. 3. Shows a linearly exploded view of the mechanical components.

FIG. 4. Shows a perspective view of the gear module with the extendable shaft.

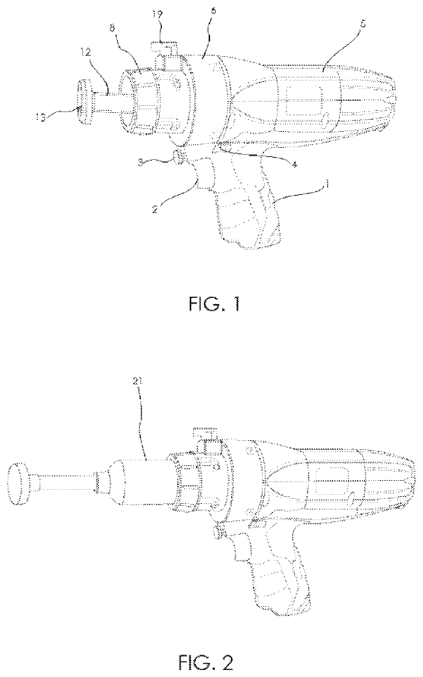

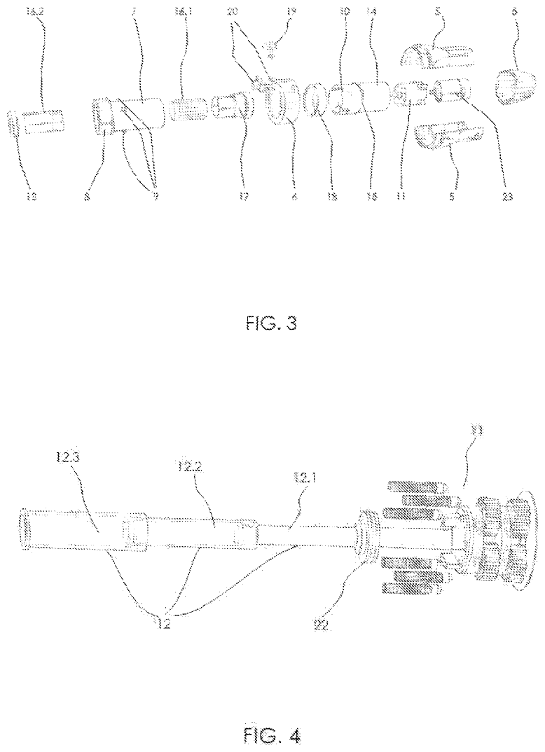

### DESCRIPTION OF A PREFERRED EMBODIMENT

According to the disclosed illustrations and always respecting the numbering present therein, a preferred, but not limiting, embodiment of the invention is explained below wherein the mixing device and applicator for sealants comprises a handle (1) which houses a trigger (2), a rotation speed regulator (3) and a rotation sense selector (4).

A modular casing or enclosure (5) rests on said handle (1) which is closed in the rear portion by means of one of said modules and in the front portion by means of a closing bushing (6) fastened thereto preferably by means of screws.

In the front portion of the device a sheath (7) is arranged with a tightening head (8) which is coupled to the device preferably by means of an anchoring system made up of a series of protuberances (9) present therein and introduced through secured tracks (10) existing in the front portion of the device.

The modular casing or enclosure (5) houses on the inside thereof the mechanisms, transmissions and gears described below;
A rotor (23).
A gear module (11) with a clutch coupled to a rotor (23) powered by an electrical current or by means of a pneumatic system.
An extendable shaft (12), projected from the gear module (11) and resting on an axial bearing (22), which is made up of a first fixed section (12.1), a second movable section (12.2), a third also movable section (12.3) both with longitudinal movement and a plunger element (13) of the pistons present in the containers (21) of sealant material.
A cylinder (14), projects from the closing bushing (6), coupled to said gear module (11) and which rests on a radial bearing (18) arranged thereon. The arrangement of the mentioned bearing on the cylinder is made between a contoured projection (15) present in the middle portion thereof and the closing bushing (6) present therein. The mentioned cylinder (14) has tracks (10) with housing in the front portion thereof.
A telescopic guiding system of the extendable shaft is located inside the cylinder (14) and is made up of an adapter (17) with a geometric transition from circular to hexagonal shapes in a preferred embodiment located between the gear module (11) and a telescopic guide made up of two movable sections (16.1 and 16.2) with an identical hexagonal geometric shape and different sizes which is dragged by the extendable shaft (12) itself. The circular portion of the adapter (17) is extended in a linear sense at a distance long enough for the container of the sealant material to fit proportionally.

Said closing bushing (6) incorporates a system for locking or releasing the rotation of the cylinder preferably made up of a retention rod (19) with a lever head and guiding and closing means (20) thereof.

1. A mixing device and applicator for sealants having a main body and a handle (1), characterised in that the main body comprises:
A removable sheath (7) for carrying containers of sealant material
A rotating cylinder (14) whereon the sheath (7) is coupled
A gear module (11) for varying rotation
An extendable shaft (12) with a telescopic guiding system
A plunger element for sealant material (13)
A rotor (23)
A modular enclosing casing (5).

2. The mixing device and applicator for sealants according to claim 1, characterised in that the sheath (7) has a head (8) for fixing the container (21) and for helping in the coupling thereof to the device.

3. The mixing device and applicator for sealants according to claim 1, characterised in that the sheath (7) is coupled to the device in the rotating cylinder (14) preferably by means of the guiding and subsequent seating of a series of protuberances (9) present in the sheath (7) along rails (10) present in the cylinder (14).

4. The mixing device and applicator for sealants according to claim 1, characterised in that the device comprises a locking or release system (19 and 20) for the rotation of the cylinder (14).

5. The mixing device and applicator for sealants according to claim 1, characterised in that the modular casing (5) has a closing bushing (6) in the front portion thereof.

6. The mixing device and applicator for sealants according to claim 1, characterised in that the rotating cylinder (14) projects from the closing bushing (6).

7. The mixing device and applicator for sealants according to claim 1, characterised in that the front portion of the cylinder (14) rests on the closing bushing (6) through a radial bearing (18) placed on the cylinder and braked by a contoured projection (15) present in the middle portion of said cylinder.

8. The mixing device and applicator for sealants according to claim 1, characterised in that an extendable shaft (12) projects from the gear module (11).

9. The mixing device and applicator for sealants according to claim 1, characterised in that the same extendable shaft (12) drags a telescopic guide made up of two movable sections (16.1 and 16.2) with edges.

10. The mixing device and applicator for sealants according to claim 1, characterised in that between the gear module (11) and the telescopic guide (16.1 and 16.2) it has an adapter (17) with a transition from circular to edged geometric shapes.

11. The mixing device and applicator for sealants according to claim 10, characterised in that the circular portion of the adapter (17) is extended in a linear sense at a distance long enough for the container of the sealant material to fit proportionally.

12. The mixing device and applicator for sealants according to claim 1, characterised in that the gear module (11) is coupled to a rotor (23) powered by an electrical current or by means of a pneumatic system.

13. The mixing device and applicator for sealants according to claim 1, characterised in that the handle houses an actuator of the rotor (2), a rotation speed selector (3) and a selector (4) of the sense thereof.
